(19) United States
(12) Patent Application Publication
(10) Pub. No.: US 2021/0165035 A1
(43) Pub. Date: Jun. 3, 2021

(54) METHOD AND DEVICE FOR DETERMINING THE CAUSE OF A FAULT IN AN ELECTRICAL CIRCUIT

(71) Applicant: Siemens Aktiengesellschaft, Munchen (DE)

(72) Inventors: Andrés Botero Halblaub, Kirchseeon (DE); Jan Fischer, München (DE); Matthias Herz, Forchheim (DE); Wilhelm Oswald, Bubenreuth (DE); Christoph Wincheringer, München (DE)

(21) Appl. No.: 16/952,336

(22) Filed: Nov. 19, 2020

(30) Foreign Application Priority Data
Nov. 28, 2019 (EP) 19212213.3

(51) Int. Cl. G01R 31/28; G06F 30/392

(52) U.S. Cl. CPC G01R 31/2803; G06F 2119/02; G06F 30/392

(57) ABSTRACT

Provided is a method and device for determining the cause of a fault in an electrical circuit by a graph-based circuit diagram simulation model of the electrical circuit. A fault is simulated in the electrical circuit and resulting connected components, and respective potential values and/or phase values of the graph vertices of the resulting connected components, are determined by reference to the modified graph-based circuit diagram simulation model, and, on the basis of the potential values and/or phase values of the graph vertices determined, the switching behavior of the electrical circuit is represented by the further addition and/or removal of at least one further graph edge. The resulting potential and/or phase values for specified graph vertices are outputted in the form of simulated output signals. The simulated output signals are compared with reference output signals for the electrical circuit, and the cause of the fault is outputted.

### CROSS-REFERENCE TO RELATED APPLICATIONS

This application claims priority to European Application No. 19212213.3, having a filing date of Nov. 28, 2019, the entire contents of which are hereby incorporated by reference.

### FIELD OF TECHNOLOGY

The following relates to a computer-implemented method and a device for determining the cause of a fault in an electrical circuit by a graph-based circuit diagram simulation model.

### BACKGROUND

During the operation of machine tools, machine outages can frequently occur, the cause of which is attributable to the electrical circuit thereof. An outage can be caused, for example, by a short-circuit or a cable break. However, on the grounds of the complexity of an electrical circuit of a conventional machine tool, in many cases, the exact location and the logical and/or temporal association with the cause of a fault can only be determined with difficulty. Determining the cause of a fault is generally based upon catalogs, in which potential causes of faults are listed in conjunction with fault phenomena observed, and/or upon a comparison of the defective machine tool with a model of identical design. These approaches can be complex, or can result in a prolonged downtime of the affected machine.

### SUMMARY

An aspect relates to the improvement of the identification of the cause of a fault, in the event of the occurrence of a fault in an electrical circuit.

According to a first aspect, embodiments of the invention relate to a computer-implemented method for determining the cause of a fault in an electrical circuit, comprising the following process steps:

a) inputting of a graph-based circuit diagram simulation model of the electrical circuit wherein, in the graph-based circuit diagram simulation model, electrical connection points of circuit components are modelled as graph vertices and electrical connections are modelled as graph edges,
b) simulation of a fault in the electrical circuit by the graph-based circuit diagram simulation model, wherein
one graph edge in the graph-based circuit diagram simulation model is added or removed,
resulting connected components, and respective potential values and/or phase values of the graph vertices of the resulting connected components, are determined by reference to the modified graph-based circuit diagram simulation model,
and wherein, on the basis of the potential values and/or phase values of the graph vertices thus determined, the switching behavior of the electrical circuit is represented by the further addition and/or removal of at least one further graph edge,
   c) outputting of resulting potential and/or phase values for specified graph vertices in the form of simulated output signals,
   d) comparison of the simulated output signals with reference output signals supplied for the electrical circuit, and
   e) outputting of the cause of the fault corresponding to the fault, where the simulated output signals correspond with the reference output signals.

One advantage of embodiments of the present invention is that a rapid and uncomplex computer-supported simulation of an electrical circuit of a technical system can be executed for the purposes of fault analysis. The graph-based circuit diagram simulation is efficient, and permits a switching operation on the electrical circuit to be simulated in real time, or close to real time. This permits the coupling of the graph-based simulation model of the electrical circuit with the actual hardware controller.

Moreover, a large number of causes of faults, and the effects thereof, can be simulated in an efficient manner such that, for example, large fault databases can be constituted. The graph-based simulation model can be easily generated from existing circuit diagram drawing plans, thereby permitting the complexity of modelling to be reduced. The graph-based simulation model moreover permits, for example, a propositional logic for the abstract representation of a control logic to be modelled and efficiently executed.

The computer-assisted simulation of a switching process, in consideration of an induced fault, is executed on the basis of the graph-based circuit diagram simulation model of the electrical circuit.

Starting from one or more output potential levels on the electrical circuit, a switching process can be simulated in a simple manner, namely by the addition and/or removal of at least one graph edge. The circuit diagram logic is represented by the iterative determination of the potential levels.

In one form of embodiment of the computer-implemented method, if the simulated output signals differ from the reference output signals, further faults can be simulated in an iterative manner, until the simulated output signals coincide with the reference output signals.

For the identification of the cause of a fault, for example, a plurality of different faults can be simulated, until the simulated output signals coincide with the reference output signals of the defective electrical circuit.

In one form of embodiment of the computer-implemented method, at least one attribute can be assigned to one graph edge and/or to one graph vertex.

An attribute can be, for example, a value of the electrical potential, or the phase.

In one form of embodiment of the computer-implemented method, a connected component can be determined by a union-find algorithm.

The known union-find algorithm permits an efficient and rapid determination of the connected components of the graph, i.e. of the graph-based circuit diagram simulation model, and thus the determination of potential levels.

In one form of embodiment of the computer-implemented method, the attributes for potential and phase values of further graph vertices of a connected component can be determined on the basis of one attribute of a graph vertex of the corresponding connected component.

In one form of embodiment of the computer-implemented method, a respective output potential value of the inputted graph-based circuit diagram simulation model can be set on the basis of a measured input signal of the electrical circuit in a predefined normal state of the electrical circuit.

For the identification of the cause of a fault, the computer-assisted simulation is advantageously executed on the basis of a normal state, or a fault-free state, of the electrical circuit.

In one form of embodiment of the computer-implemented method, the switching logic, the switching contacts and/or the circuit components of the electrical circuit can be hierarchically modelled in the graph-based circuit diagram simulation model.

A circuit component such as e.g. a relay, having a coil and switching contacts, can be modelled in the form of a group of graph edges and graph vertices. This permits, for example, a simple removal and/or addition of circuit components. The switching logic, i.e. the mutual relationship of individual circuit components to one another, can be represented within a group of this type. For example, switching contacts, as defined graph edges, are dependent upon the coil voltage, and thus upon the potential difference between the two graph vertices of the coil terminals.

According to a second aspect, embodiments of the invention relate to a device for determining the cause of a fault in an electrical circuit, comprising at least one processor, wherein the device is designed to execute the steps of the method according to embodiments of the invention.

In one form of embodiment, the device can be coupled to an actual or simulated controller, wherein the simulation output signals are transmitted to the actual controller or the simulated controller.

Efficient graph-based simulation permits, for example, coupling to the actual controller of a machine tool. Thus, for example, a hardware-in-the-loop approach can be executed. Alternatively, the graph-based simulation can be coupled to a simulated controller. Output signals from the controller can be processed in the simulation.

Embodiments of the invention moreover relate to a computer program product (non-transitory computer readable storage medium having instructions, which when executed by a processor, perform actions), which can be loaded directly into a programmable computer, comprising program code elements which, during the running of the program on a computer, initiate the execution by the latter of the steps of a method according to embodiments of the invention.

A computer program product can be provided or supplied, for example, on a storage medium such as e.g. a memory card, a USB stick, a CD-ROM or DVD, a non-volatile/permanent storage medium (or “non-transitory storage medium”), or in the form of a file which is downloadable from a network server.

### BRIEF DESCRIPTION

Some of the embodiments will be described in detail, with references to the following Figures, wherein like designations denote like members, wherein:

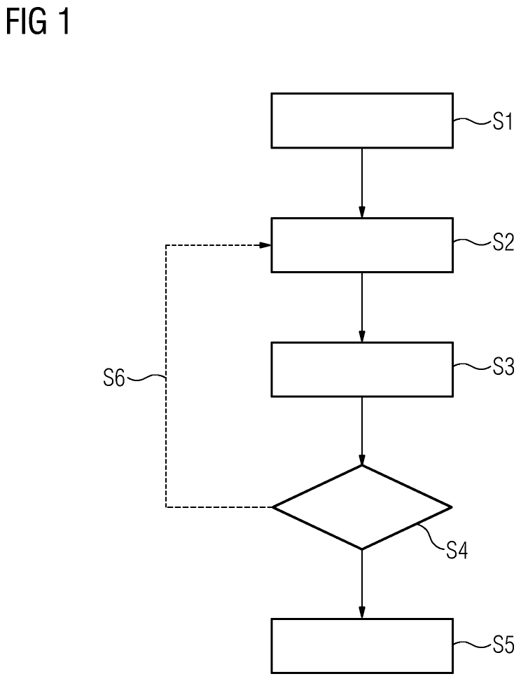

FIG. 1 shows a flow diagram of a computer-implemented method for determining the cause of a fault in an electrical circuit;

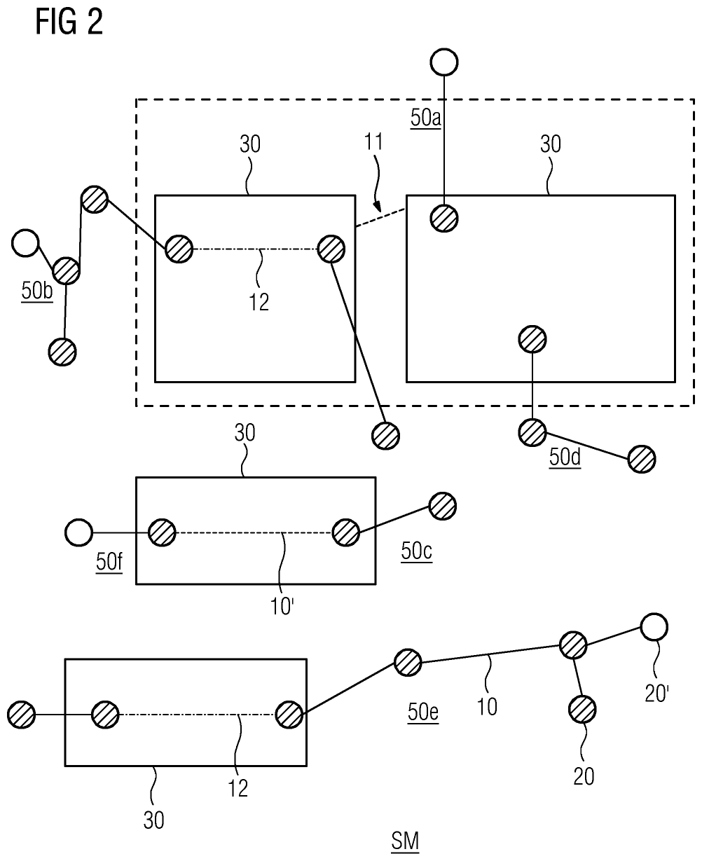

FIG. 2 shows a schematic representation of a graph-based circuit diagram simulation model; and

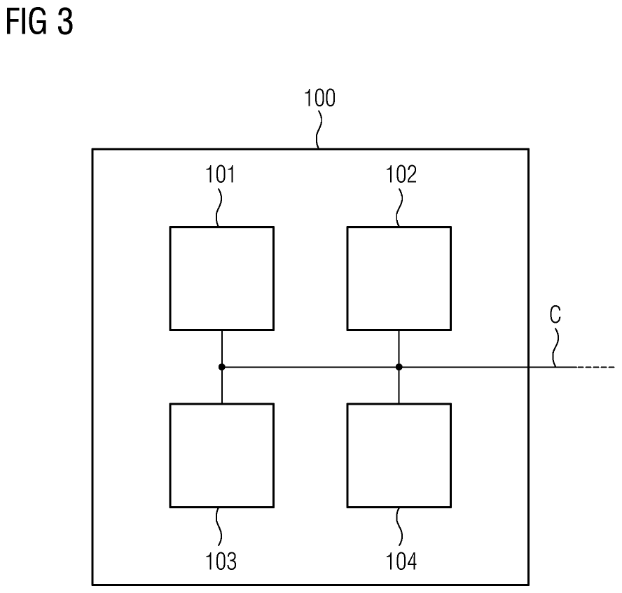

FIG. 3 shows a schematic representation of a device for determining the cause of a fault in an electrical circuit.

### DETAILED DESCRIPTION

The following exemplary embodiments represent exemplary possibilities of execution only, wherein such executions might be considered to constitute the instruction incorporated in embodiments of the invention, on the grounds that it is not possible, and is neither expedient nor necessary for the understanding of embodiments of the invention, for all these possibilities of execution to be specified.

FIG. 1 shows a flow diagram of a computer-implemented method for determining the cause of a fault in an actual electrical circuit. This can involve, for example, a defect in the electrical circuit of a machine tool. The cause and/or location of the defect can be efficiently determined by the computer-implemented method, for example, in parallel with the operation of the actual machine tool.

In the first step S1 of the computer-implemented method, a graph-based circuit diagram simulation model of the electrical circuit is inputted. The graph-based circuit diagram simulation model, for example, can be generated using data from a circuit diagram or an electrical design layout. The graph-based circuit diagram simulation model represents the circuit diagram of a technical system, e.g. of a machine tool.

The graph-based circuit diagram simulation model is configured such that electrical connection points of the circuit components of the actual circuit are modelled as graph vertices and electrical connections as graph edges. Graph vertices can be characterized, for example, by an electrical potential value, and by a phase value, in the case of an alternating current. Graph vertices which are interconnected by a common graph edge indicate the same phase or potential value.

A potential value or phase value on a circuit component of the actual circuit can vary, for example as a result of a switching process or a step in a switching process, or as a result of the occurrence of a fault. As described hereinafter, this can be represented by the graph-based circuit diagram simulation model.

The initial setting of the graph-based circuit diagram simulation model is such that output potential values correspond to a normal state, i.e. an error-free state, of the electrical circuit. For example, output potential values of graph vertices can be set on the basis of measured input signals of the electrical circuit in the normal state.

Attributes can be assigned to the graph edges and/or graph vertices in each case. An attribute can be, for example, a potential value or a phase value. Thus, for example, by reference to the respectively associated attributes, the voltage present on a circuit component can be determined as the differential of the potential values on the graph vertices of the circuit component vis-à-vis the same ground reference.

With reference to the graph-based circuit diagram simulation model, connected components of the graph are determined. This determination can be executed by the union-find algorithm. A connected component constitutes a quantity of graph vertices wherein, in each case, any two of the graph vertices are connected by a path, i.e. at least one graph edge or a sequence of graph edges. Potential values can be respectively determined for the graph vertices of a connected component. A connected component describes a potential level in the circuit diagram.

For example, by reference to the inputted graph-based circuit diagram simulation model, potential values of the graph vertices of the respectively determined connected components can be determined in the form of output potential values. A simulation of a switching process or of the switching behavior of the electrical circuit, by the graph-based circuit diagram simulation model, can be executed on the basis of these connected components and respective output potential values thus determined.

In the next step S2, a fault in the electrical circuit, such as, e.g., a cable break in a specific location, is simulated by the graph-based circuit diagram simulation model. In other words, a fault in the electrical circuit is modelled, and a switching behavior of the electrical circuit is simulated in consideration of the fault.

To this end, the fault is modelled by the deletion of an existing graph edge and/or the saving or addition of a new graph edge in the graph-based circuit diagram simulation model. For example, a cable break can be modelled by the removal of a graph edge. A short-circuit can be modelled, for example, by the insertion of an additional graph edge. The graph-based circuit diagram simulation model is modified accordingly, for the purposes of fault simulation. Further steps are then executed on the basis of this modified graph-based circuit diagram simulation model.

Thereafter, by reference to the modified graph-based circuit diagram simulation model, connected components are calculated by the union-find algorithm. These resulting connected components are generated by the modification of the circuit diagram simulation model. For these newly-calculated connected components, potential values and/or phase values for the graph vertices of the connected components are determined. On the basis of the potential values and/or phase values for the graph vertices thus determined, the switching behavior or switching logic of the electrical circuit is evaluated, wherein at least one further graph edge is added or deleted.

For example, for the opening of a switching contact in accordance with the switching logic, e.g. by an opening contact of a relay which is to be switched-in on the basis of the circuit logic or a closing contact of a relay which is to be switched-out on the basis of the circuit logic, a graph edge in the graph-based circuit diagram simulation model can be removed and, for the closing of a switching contact in accordance with the switching logic, e.g. by a closing contact of a relay which is to be switched-in or an opening contact of a relay which is to be switched-out, a graph edge in the graph-based circuit diagram simulation model can be added. Integration of switching logic in the simulation can be executed by logic modules, which implement the addition and removal of graph edges in accordance with potential levels at other locations in the graph, e.g. in order to simulate the behavior of a contactor. As this involves simple logic modules, the speed of simulation is not impaired as a result.

The potential values of the graph vertices of a connected component, for example, can all assume the same potential value. In other words, provided that at least one graph vertex of a connected component possesses a potential value by way of an attribute, and all the other graph vertices of the connected component assume either no potential value or the same potential value as the graph vertex and, where present, the same phase value as the graph vertex by way of an attribute, the attribute of the potential value of this graph vertex and, where present, the attribute of the phase value of this graph vertex define the corresponding potential values and, where applicable, the phase values of the respective connected component, i.e. of all the vertices of the respective connected component. If no graph vertex of a connected component assumes a potential value by way of an attribute, the potential and phase value attributes of all the graph vertices of the connected component remain undefined. Provided that the potential value and, where applicable, the phase value of two different graph vertices of a connected component are defined, and the potential values or, where applicable, the phase values show a mutual difference, an electrical short-circuit is present in the connected component. The short-circuit between these two graph vertices, together with the potential and, where applicable, phase values of the graph vertices, are outputted.

The respective attribute values for potential and phase values of all the graph vertices of the connected component, or the property “undefined”, can be outputted.

Simulation of the switching logic is executed in an iterative manner, i.e. further to a modification of the graph-based circuit diagram simulation model, a determination of the connected components is executed, followed by a determination of the potential values of the graph vertices and, depending upon the potential values, a switching process is represented by the addition or deletion of graph edges, until such time as the potential values and, where applicable, phase values, and thus the switching logic-dependent states of the graph edges thus dictated, undergo no further change.

In other words, in the simulation of the switching process, potential values and phase values of the graph vertices are determined iteratively, and the switching logic is executed until a stable potential level is achieved. The resulting graph, i.e. the resulting graph-based circuit diagram simulation model, is outputted.

In order to permit the representation of the true behavior of the technical system, the simulation is coupled with an actual controller of the technical system (hardware-in-the-loop), with a model of the controller (model-in-the-loop), or with a copy of the control software which, however, is not run on the actual hardware of the controller (software-in-the-loop). The graph-based circuit diagram simulation model thus receives the output signals from the controller and feeds the simulated input signals of the controller back to the latter.

In the following step S3, for specified graph vertices of the resulting graph-based circuit diagram simulation model, the iteratively determined potential or phase values are outputted in the form of simulated output signals.

In the next step S4, these simulated output signals are compared with reference output signals supplied from the actual electrical circuit. The reference output signals are measured on the defective circuit. In other words, a defective actual state of the electrical circuit of the technical system can be measured by an actual controller. Measured output signals from the electrical circuit can be supplied as reference output signals.

If the reference output signals coincide with the simulated output signals, at least partially, i.e. for example, within a predefined tolerance range, a cause of the fault is outputted in step S5. The cause of the fault is deduced from the respectively simulated fault. For example, the location and the cause “cable break” or “short-circuit” of the fault can be delivered as an output to an engineer.

If the reference output signals do not coincide with the simulated output signals, or the coincidence lies outside the predefined tolerance range, at least one further fault can be simulated—see step S6. Accordingly, identification of the cause of the fault can be executed iteratively, wherein the graph-based circuit diagram simulation model is correspondingly modified for the simulation of a further fault. A result of the preceding simulation, for example, can provide an indication for the deduction of the next fault to be tested.

Accordingly, identification of the cause of the fault is executed iteratively, until the simulated output signals coincide with the reference signals. The graph-based approach permits a rapid iteration for various causes of faults.

FIG. 2 shows a schematic representation of a visualization of a graph-based circuit diagram simulation model SM of an electrical circuit. The electrical circuit can be represented in the form of an undirected graph.

In the graph-based circuit diagram simulation model SM, the switching logic, the switching contacts and/or the circuit components are hierarchically modelled. The structure of the graph-based circuit diagram simulation model SM is represented here in an exemplary manner. In order to represent the switching logic of a circuit diagram in the computer-assisted simulation, graph edges 10 can be inserted and/or deleted. For example, the logic of a switch can be modelled by the insertion or deletion of at least one graph edge 10.

The electrical connection points of circuit components are modelled in the form of graph vertices 20, and electrical connections, such as e.g. cables or printed conductors, are modelled in the form of graph edges 10. Graph vertices 20 can be of the source type 20′, the branch type or the port type. A potential and phase value can be assigned to a graph vertex 20, by way of an attribute. The sources 20′ can define the potential and/or phase value.

Physical or electrical connections between the graph vertices 20 are modelled by the graph edges 10. Accordingly, graph vertices 20 which are connected by a graph edge 10 assume the same phase and potential value. Graph edges 10 can be modelled in the form of conditional graph edges 12, which are dependent upon a circuit component. Graph edges 10 can be inserted or removed. One graph edge 10′ is represented which, for example, can be removed in order to simulate a fault.

Graph vertices 20 and graph edges 10, 12 can be grouped in order to represent electrical circuit components 30 such as e.g. a contactor coil or a switching contact. An electrical circuit component 30 can comprise more than one of the connected components 50a, . . . , 50f. The connected components 50a, . . . , 50f respectively comprise a composite quantity of graph vertices 20 having a given potential and phase value. A connected component 50a, . . . , 50f can be defined by the union-find algorithm, according to Robert Endre Tarjan.

An electrical circuit component 30 thus constitutes a superordinate level in the circuit diagram simulation model. The electrical circuit components 30 can be interconnected by a logical connection 11. A logical connection 11 of this type, is not represented by a graph edge.

FIG. 3 shows a schematic representation of a device 100 for determining the cause of a fault in an electrical circuit. The device comprises at least one processor 101, and is designed to execute the steps of a method for determining the cause of a fault in an electrical circuit, as described in an exemplary manner with reference to FIG. 1. The device 100 can moreover comprise a simulation module 102, which is designed to simulate a fault in the electrical circuit by an inputted graph-based circuit diagram simulation model. The device 100 can moreover comprise an analysis module 103, which is designed to execute a comparison of the simulated output signals with reference output signals supplied from the electrical circuit, in order to determine the cause of a fault. Depending upon the result of the comparison, the cause of the fault thus determined can be outputted, for example by an output module 104. The device 100 can be coupled to an actual controller by a connection C such that, for example, a hardware-in-the-loop simulation can be executed.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A computer-implemented method for determining a cause of a fault in an electrical circuit, the method comprising:
a) inputting a graph-based circuit diagram simulation model of the electrical circuit wherein, in the graph-based circuit diagram simulation model, electrical connection points of circuit components are modelled as graph vertices and electrical connections are modelled as graph edges,
b) simulating a fault in the electrical circuit by the graph-based circuit diagram simulation model, wherein:
one graph edge in the graph-based circuit diagram simulation model is added or removed,
resulting connected components, and respective potential values and/or phase values of graph vertices of the resulting connected components, are determined by reference to a modified graph-based circuit diagram simulation model,
and, on a basis of the potential values and/or phase values of the graph vertices determined, the switching behavior of the electrical circuit is represented by the further addition and/or removal of at least one further graph edge,
c) outputting resulting potential and/or phase values for specified graph vertices in a form of simulated output signals,
d) comparing the simulated output signals with reference output signals supplied for the electrical circuit, and
e) outputting the cause of the fault corresponding to the fault, where the simulated output signals correspond with the reference output signals.

2. The computer-implemented method as claimed in claim 1, wherein if the simulated output signals differ from the reference output signals, further faults are simulated in an iterative manner, until the simulated output signals coincide with the reference output signals.

3. The computer-implemented method as claimed in claim 1, wherein at least one attribute is assigned to one graph edge and/or to one graph vertex.

4. The computer-implemented method as claimed in claim 1, wherein a connected component is determined by a union-find algorithm.

5. The computer-implemented method as claimed in claim 1, wherein attributes for potential and phase values of further graph vertices of a connected component are determined on the basis of one attribute of a graph vertex of the corresponding connected component.

6. The computer-implemented method as claimed in claim 1, wherein a respective output potential value of the inputted graph-based circuit diagram simulation model is set on a basis of a measured input signal of the electrical circuit in a predefined normal state of the electrical circuit.

7. The computer-implemented method as claimed in claim 1, wherein the switching logic, the switching contacts and/or the circuit components of the electrical circuit are hierarchically modelled in the graph-based circuit diagram simulation model.

8. A device for determining the cause of a fault in an electrical circuit, comprising at least one processor, wherein the device is designed to execute the steps of the method as claimed in claim 1.

9. The device as claimed in claim 8, which is coupled to an actual or a simulated controller, wherein the simulation output signals are transmitted to the actual or the simulated controller.

10. A computer program product, comprising a computer readable hardware storage device having computer readable program code stored therein, said program code executable by a processor of a computer system to implement the method as claimed in claim 1.
